(19) United States
(12) Patent Application Publication
(10) Pub. No.: US 2008/0103988 A1
(43) Pub. Date: May 1, 2008

(54) Systems and methods for tracking investment metrics

(75) Inventors: Trevor Samuel Harris, Closter, NJ (US); Marc Daniel Donner, New York, NY (US); Courtney Stafford Cook, Rye, NY (US)

Correspondence Address: KIRKPATRICK & LOCKHART PRESTON GATES ELLIS LLP, 535 SMITHFIELD STREET, PITTSBURGH, PA, 15222, US

(73) Assignee: Morgan Stanley, New York, NY (US)

(21) Appl. No.: 11/809,087

(22) Filed: May 31, 2007

Related U.S. Application Data
(60) Provisional application No. 60/809,731, filed on May 31, 2006.

(51) Int. Cl. G06Q 40/00

(52) U.S. Cl. 705/36 R; 705/35

(57) ABSTRACT

An interactive user interface for displaying information about one or more publicly traded companies at one time. The interface may comprise a two-dimensional chart comprising an x-axis and a y-axis and means for specifying financial metrics for the x- and y-axes. The interface may also include fields where the user can select the companies whose data is to be displayed on the chart. The interface may also include a time range selection field where the user can specify the date range for the date to be displayed on the chart. An identifier or other type of marker is positioned on the chart at the x and y coordinates for each of the publicly traded companies for each time point in the time range. Further, the markers for each company may be connected by a line. The line for each of the companies may be labeled with an identifier for the company (e.g., stock trading symbol) and each marker is labeled with a date indicator. The interface may further comprise a contour selection field for specifying a type of contour lines to be applied to the chart.

### CROSS-REFERENCE TO RELATED APPLICATIONS

The present application claims priority to U.S. provisional application Ser. No. 60/809,731 filed May 31, 2006, entitled “Systems and methods for tracking investment metrics,” by T. Harris et al., which is incorporated herein by reference.

### BACKGROUND

Various metrics are tracked for securities of publicly traded corporations so that investors, brokers, analysts, corporations, etc. may make investment decisions based on historical information and trends. Such metrics are usually tracked over time and are often plotted on two-dimensional graphs with one axis representing time and the other axis representing a measure of the tracked metric. For example, metrics such as operating margin, asset turnover, revenue growth, revenue, operational asset growth, price per earnings, earnings growth, enterprise value to net operational assets, return on net operational assets, price to book ratio, return on equity, debt to capital ratio, dividend payout ratio, spread, leverage ratio, etc. may be tracked against time.

The ability of analysts and other users of such information to visualize multiple parameters for numerous companies at a time in a meaningful way, however, is limited. The users could use a table containing the data, but such tables are often hard to interpret and do not lend themselves to easy visual analysis and inspection.

### SUMMARY

In one general aspect, the present invention is directed to an interactive user interface for displaying information about one or more publicly traded companies at one time. According to one embodiment, the interface may comprise a two-dimensional chart comprising an x-axis and a y-axis and means for specifying financial metrics for the x- and y-axes. The means for specifying the financial metrics may include, for example, drop-down window where the user can select the desired metrics for the respective axes, or the user may select the metrics from a list of pre-established, informative metric pairings. The interface may also include fields (e.g., drop-down window) where the user can select the companies whose data is to be displayed on the chart. The interface may also include a time range selection field where the user can specify the date range for the date to be displayed on the chart. An identifier or other type of marker is positioned on the chart at the x and y coordinates for each of the publicly traded companies for each time point in the time range. Further, the markers for each company may be connected by a line. The line for each of the companies may be labeled with an identifier for the company (e.g., stock trading symbol) and each marker is labeled with a date indicator.

According to various implementations, the interface may further comprise a contour selection field for specifying a type of contour lines to be applied to the chart. Possible selections for the contour lines include (1) where the x value times the y-value equals a constant and (2) where the y-value divided by the x-value equals a constant. The selected contour lines may be displayed on the chart, which may facilitate the user's ability to evaluate the displayed information.

To further aid in the user's ability to evaluate the information, the interface may further comprise a center chart axis selection field that, when selected, centers the x and y axes in the chart. The interface may also comprise zoom selection fields for the x- and y-axes to allow the user to zoom in on the chart in one or both dimensions. The interface may further comprise fields which allow the user to specify the minimum and maximum values for the axes.

Other embodiments of the present invention are directed to related systems and methods for displaying the interface.

### FIGURES

Various embodiments of the present invention are described herein by way of example in conjunction with the following figures wherein:

FIGS. 1-2 depict examples of an interactive user interface according to various embodiments of the present invention; and

FIG. 3 depicts a system for displaying the interface according to various embodiments of the present invention.

### DETAILED DESCRIPTION

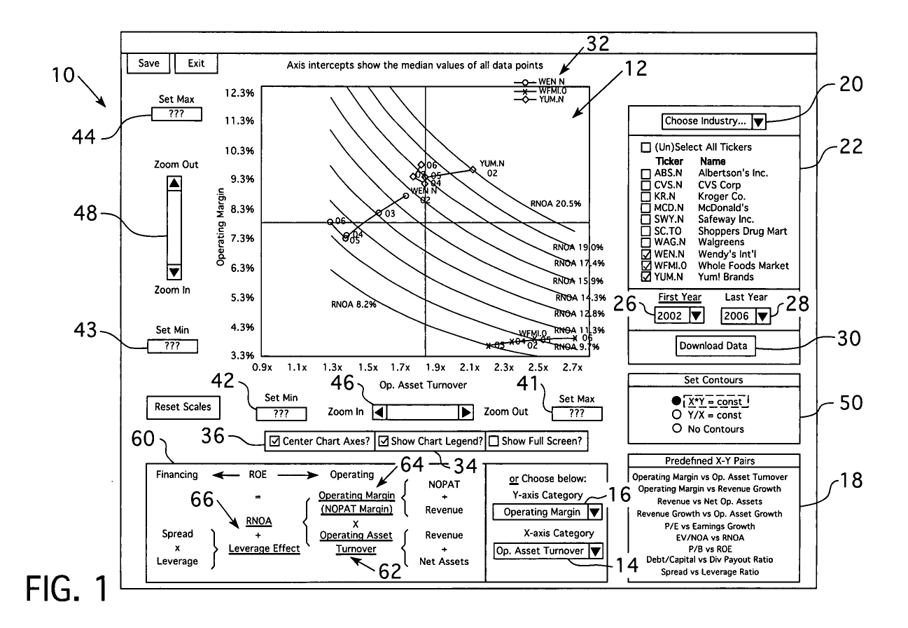

FIG. 1 is a diagram of an interactive user interface 10 according to various embodiments of the present invention. The interface 10 may include a multi-dimensional chart, or plot, 12 that displays investment metrics relating to publicly-traded companies and/or their issued securities. Further, the user may be able to define aspects of the chart 12 to facilitate the user's analysis of the information. As user, such as a securities analyst or investor, for example, may be presented with the interface 10 using a computer-based system as described further below in connection with FIG. 4.

The chart 12 may display the points and/or connecting lines corresponding to coordinates for chosen metrics corresponding to the x- and y-axes for one or more publicly-traded companies. According to various embodiments, the user may select the metrics for the x- and y-axis using drop-down selection fields 14, 16. The drop-down selection fields 14, 16 may be pre-populated with numerous financial metrics that the user can select with his/her mouse or other activation device. The metrics from which the user can select for either the x- or y-axes may include (but is not limited to): net operating profit after tax (NOPAT), operating margin, revenue, revenue growth, R&D, R&D/Sales, SG&A, SG&A/Sales, return on net operating assets (RNOA, also called ROIC), return on equity (ROE), earnings per share (EPS), EPS growth, operating asset turnover, net operating assets (NOA), net operating asset growth, shareholders equity, capital expenditures (capex), capex growth, dividends per share, dividend payout ratio, net return of capital ratio, net return of capital yield, debt/capital, debt/equity, enterprise value (EV), EV/NOA, equity to assets ratio, net borrowing cost, net debt, price to earnings ratio, price to book ratio, price to tangible book ratio, price to free cash flow ratio, EV/EBITDA. This listing is only a representative sample of the possible metrics that may be used. In other embodiments, other and/or additional financial metrics may be used. Also, time may be selected for one of the axes (such as the x-axis) so that the change of a metric over time may be plotted.

In addition, the interface 10 may include a list of useful-x-y pairs in a field 18 for the x- and y-axis that the user can select by clicking on the desired pair. According to various embodiments, the list of useful pairs may include:

| Y-Axis | X-Axis |
|---|---|
| Operating Margin | Op. Asset Turnover |
| Operating Margin | Revenue Growth |
| Revenue | Net Op. Assets |
| Revenue Growth | Op. Asset Growth |
| P/E | Earnings Growth |
| EV/NOA | RNOA |
| P/B | ROE |
| Debt/Capital | Div Payout Ratio |
| Spread | Leverage Ratio |

### Of course, in other embodiments, more, fewer, and/or different predefined pairs may be used.

According to various embodiments, the user may select the publicly-traded companies that are displayed in the chart 12 by first selecting an industry sector from a drop-down selection field 20. Once an industry sector is selected, the field 22 below the drop-down selection field 20 may be selected with selection boxes publicly-traded companies in the selected industry sector. The field 22 may show the users trading symbol and name. The user may select one or more of the companies displayed in the field 22. The user may also select (or deselect, as the case may be) all of the companies in the industry sector by selecting the “Select All Tickers” (or similarly named) selection box 24.

The user may also select the time range for the metric data to be displayed using start and end time drop-down selection fields 26, 28. Once the companies and time frame have been selected, the user may download the necessary data by activating the “Download Data” button 30.

In the illustrated embodiment, three companies were selected (WEN.N, WFMI.O and YUM.N), the x-axis was selected to be operating asset turnover, and the y-axis was selected to be operating margin. The time frame from 2002 to 2006 was selected. The plots for each of the selected companies may be displayed in the chart 12 using different colors and line patterns to distinguish the different companies. A legend 32 may indicate which company corresponds to each color/line pattern. In various embodiments, the user can select whether the legend 32 is displayed using the legend display selection box 34.

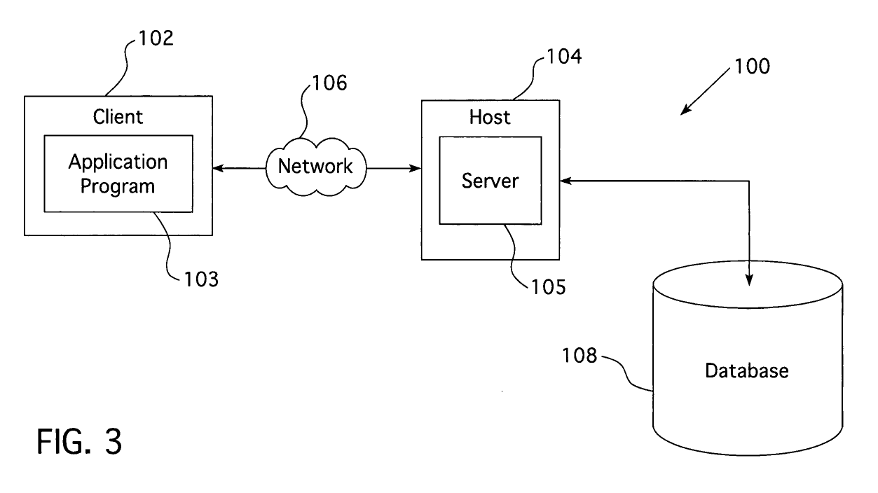

According to various embodiments, the interface 10 may also include a number of fields which allow the user to further define aspects of how the information is displayed. For example, the user may select whether the axes are centered in the chart 12 using the chart center axes selection box 36. When the user selects to center the axes, the host server (see FIG. 3) may calculate the median value for each axis (x and y) and identify the maximum and minimum data points on each axis. Then both (1) the maximum minus the median and (2) the minimum minus the median may be calculated, with the greater of the two (in absolute magnitude) being the “width” for the chart 12. As such, the y-axis may pass through the median x-value and the x-axis may pass through the median y-value. To center each axis in the chart space, the width is added to each side of the media (for each dimension) to set the end values of each axis. FIG. 1 is an example where the axes are centered.

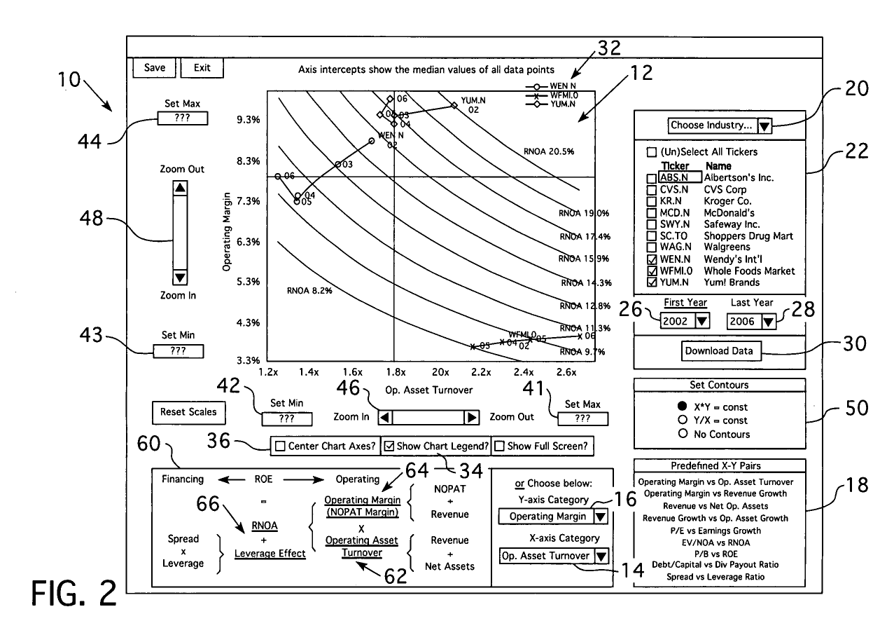

FIG. 2 is an example of the same chart as FIG. 1 but without the axes centered. In such a mode, the axes endpoints may be selected to maximize the available chart space to display the data points. The low value of the x-axis may be set equal to the minimum value of the x-values of the dataset and the high-value of the x-axis may be set equal to the maximum value of the x-values of the dataset. The low and high values for the y-axis may be established in a similar manner. As such, the axes are not forced to be (and likely will not be) centered within the chart 12 in this display mode.

In addition, according to various embodiments, the interface 10 may include fields 41-44 where the user can specify one or more of the endpoints for x- and y-axes. If the user only enters one endpoint for an axis in this mode, the other endpoint may be automatically selected to correspond to the highest or lowest value in the dataset for the axis, as the case may be depending on the endpoint that is selected by the user.

In addition, the interface 10 may include x- and y-axis zoom selection fields 46, 48. Utilizing either or both zoom selection field 46, 48, the user may zoom in on and magnify a desired portion of the chart 12. In such a mode, a fraction of the width (e.g., ranging from 10% to 100% of the width) can be added to each side of the median value for the axis where the zoom is used (e.g., the x-axis only, the y-axis only, or both the x- and y-axes).

The data points plotted in the chart 12 may be labeled with a data series identifier and/or a date label. In the example shown in FIG. 1, each data series identifier is the trading (or ticker) symbol for the company and it is placed adjacent to the first chronological point. The points are also marked with a date label, in this example, the last two digits of the year (e.g., 02, 03, 04, etc.).

In addition, the interface 10 may allow the user to apply contour lines to the graph 12 using contour selection buttons 50. In the illustrated embodiment, there are three contour selection buttons 50. The first one is where the x-value multiplied by the y-value is a constant (or a range of different constants where multiple contour lines are applied). The second option is where the y-value divided by the x-value is a constant (or range of constants). The third is where no contour lines are applied. This may be the default setting in various embodiments. In other embodiments, options for contour lines using more complex x and y value relationships may be provided. Also, in some embodiments, the user may be able to specify custom relationships for the contour lines.

In the example shown in FIG. 1, the “X*Y=const” contour option is selected and the graph 12 includes ten equally-spaced contours that represent x times y. According to various embodiments, to plot the contour lines, the values of x*y for each data point is calculated. The maximum and minimum products may represent the outer bands of the contour bands. Then the values for the remaining eight contour lines may be interpolated. In such an embodiment, the ten contour lines may be applied at:

1. Min(x*y)

2. Min(x*y)+(Max(x*y)−Min(x*y))*1/10

3. Min(x*y)+(Max(x*y)−Min(x*y))*2/10

4. Min(x*y)+(Max(x*y)−Min(x*y))*3/10

. . .

9. Min(x*y)+(Max(x*y)−Min(x*y))*9/10

10. Max(x*y)

In other embodiments, more or fewer contour lines may be used, with the placement of the lines in the chart 12 determined in an analogous fashion. In certain embodiments, the user may specify the desired number of contour lines.

Some metric pairs produce meaningful products or ratios that provide additional information when plotted as contours. An example of the form (contour metric)=(Y-metric)×(X-metric) that may be useful is: RNOA=(operating margin)×(operating asset turnover). Examples of the form (contour metric)=(Y-metric)/(X-metric) that may be useful include:
leverage=(debt)/(shareholders equity)
operating margin=(NOPAT)/(revenue)

As shown in FIG. 1, the interface 10 may also include a metric map 60 that allows users to navigate between metric pairs. Using the example shown in FIG. 1, the user could select the operating asset turnover link 62, in which case the chart 12 may be configured to display revenue on the y-axis and net assets on the x-axis. If the user selected the NOPAT margin link 64, the chart 12 may be configured to display revenue on the y-axis and NOPAT on the x-axis. The user could also select the RNOA link 66, in which case the chart 12 may be configured to display NOPAT margin on the y-axis and operating asset turnover on the x-axis. By selecting the leverage effect link 68, the chart 12 may be configured to display spread on the y-axis and leverage on the x-axis. As the map field 60 indicates, return on equity (ROE) equals RNOA plus leverage effect.

FIG. 3 is a diagram of a system 100 for presenting the interface 10 to a user according to various embodiments. The user may view the interface 10 at a client device 102, which may include an application program 103, such as a web browser, for displaying the interface 10. The client device 102 may be any type of device capable of receiving, rendering and displaying the interface 10 such as, for example, a portable computer (PC), a laptop computer, a workstation, a web-enabled telephone, etc. The interactive user interface 10 may be, for example, part of a web page or other document that is served to the client device 102 from a host 104 through a network 106. The host 104 which is shown as a single device in FIG. 4 but which may be embodied as a series of networked computing devices, may include a server 105 for generating the web pages or documents comprising the interface 10 based on data stored in one or more databases 108. The server 105 may serve the generated web pages or documents via the network 106 to the client device 102. In that way, the interface 10 may be displayed to the user in real time or near real time.

According to various embodiments, the database(s) 108 may include the data necessary to generate the chart 12, such as the data for the various metrics that can be displayed on the chart 12. The data in the database(s) 108 may be based on, for example, data feeds from sources and/or analyst models used to model the securities of publicly traded companies.

Various embodiments of the present invention are also directed to methods of presenting information to a user (e.g., an analyst) about a plurality of publicly traded securities at one time using the interactive user interface. The method may comprise displaying the user interface to the user.

While several embodiments of the present invention have been described herein, it should be apparent that various modifications, alterations and adaptations to those embodiments may occur to persons skilled in the art. It is therefore intended to cover all such modifications, alterations and adaptations without departing from the scope and spirit of the present invention as defined by the appended claims.

What is claimed is:

1. An interactive user interface for displaying information about one or more publicly traded companies at one time, comprising:
a two-dimensional chart comprising an x-axis and a y-axis;
means for specifying a first financial metric related to the one or more publicly traded companies for the x-axis and for specifying a second financial metric related to the one or more publicly traded companies for the y-axis;
a time range selection field, wherein a marker is positioned on the chart at the x and y coordinates for each of the publicly traded companies for each time point in the time range, and wherein, separately for each of the one or more publicly trade companies, the markers are connected by a line.

2. The interface of claim 1, further comprising a contour selection field for specifying a type of contour lines to be applied to the chart.

3. The interface of claim 2, wherein the contour selection field includes as one selection a set of contour lines where a value for the x-axis times a value for the y-axis equals a constant.

4. The interface of claim 3, wherein the contour selection field includes as another selection a set of contour lines where a value for the y-axis divided by a value for the x-axis equals a constant.

5. The interface of claim 2, wherein the means for specifying the first financial metric related to the one or more publicly traded companies for the x-axis and for specifying the second financial metric related to the one or more publicly traded companies for the y-axis comprises:
a first drop-down window for the x-axis that allows a user to select one of a plurality of financial metrics for the x-axis; and
a second drop-down window for the y-axis that allows a user to select one of a plurality of financial metrics for the y-axis.

6. The interface of claim 2, wherein the means for specifying the first financial metric related to the one or more publicly traded companies for the x-axis and for specifying the second financial metric related to the one or more publicly traded companies for the y-axis comprises a listing of predefined x-y pairs.

7. The interface of claim 2, further comprising a center chart axis selection field that, when selected, centers the x and y axes in the chart.

8. The interface of claim 7, further comprising:
a zoom selection field for the x-axis; and
a zoom selection field for the y-axis.

9. The interface of claim 8, further comprising:
a maximum x-axis value selection field;
a minimum x-axis value selection field;
a maximum y-axis value selection field; and
a minimum y-axis value selection field.

10. The interface of claim 9, further comprising a name selection field for specifying the publicly traded companies.

11. The interface of claim 10, wherein the name selection field comprises an industry selection field.

12. The interface of claim 11, wherein the lines for each of the publicly traded companies is labeled with an identifier for the company and each marker is labeled with a data indicator.

13. A system for providing an interactive user interface to a user, the interactive user interface for displaying information about a plurality of publicly traded securities at one time, the system comprising a server for serving a document containing the interactive user interface via a network to the user, the interactive user interface comprising:
a two-dimensional chart comprising an x-axis and a y-axis;
means for specifying a first financial metric related to the one or more publicly traded companies for the x-axis and for specifying a second financial metric related to the one or more publicly traded companies for the y-axis;
a time range selection field, wherein a marker is positioned on the chart at the x and y coordinates for each of the publicly traded companies for each time point in the time range,

14. The system of claim 13, wherein the interface further comprises a contour selection field for specifying a type of contour lines to be applied to the chart.

15. The system of claim 14, wherein the contour selection field includes as one selection a set of contour lines where a value for the x-axis times a value for the y-axis equals a constant.

16. The system of claim 15, wherein the contour selection field includes as another selection a set of contour lines where a value for the y-axis divided by a value for the x-axis equals a constant.

17. The system of claim 14, wherein the means for specifying the first financial metric related to the one or more publicly traded companies for the x-axis and for specifying the second financial metric related to the one or more publicly traded companies for the y-axis comprises:
a first drop-down window for the x-axis that allows a user to select one of a plurality of financial metrics for the x-axis; and
a second drop-down window for the y-axis that allows a user to select one of a plurality of financial metrics for the y-axis.

18. The system of claim 14, wherein the means for specifying the first financial metric related to the one or more publicly traded companies for the x-axis and for specifying the second financial metric related to the one or more publicly traded companies for the y-axis comprises a listing of predefined x-y pairs.

19. The system of claim 14, wherein the interface further comprises a center chart axis selection field that, when selected, centers the x and y axes in the chart.

20. The system of claim 19, wherein the interface further comprises:
a zoom selection field for the x-axis; and
a zoom selection field for the y-axis.

21. The system of claim 20, wherein the interface further comprises:
a maximum x-axis value selection field;
a minimum x-axis value selection field;
a maximum y-axis value selection field; and
a minimum y-axis value selection field.

22. The system of claim 21, wherein the interface further comprises a name selection field for specifying the publicly traded companies.

23. The system of claim 22, wherein the name selection field comprises an industry selection field.

24. The system of claim 23, wherein the lines for each of the publicly traded companies is labeled with an identifier for the company and each market is labeled with a data indicator.

25. A method of presenting information about a plurality of publicly traded securities at one time in an interactive user interface comprising displaying a user interface, wherein the user interface comprises:
a two-dimensional chart comprising an x-axis and a y-axis;
means for specifying a first financial metric related to the one or more publicly traded companies for the x-axis and for specifying a second financial metric related to the one or more publicly traded companies for the y-axis;
a time range selection field, wherein a marker is positioned on the chart at the x and y coordinates for each of the publicly traded companies for each time point in the time range, and wherein, separately for each of the one or more publicly trade companies, the markers are connected by a line.

26. The method of claim 25, wherein the interface further comprises a contour selection field for specifying a type of contour lines to be applied to the chart.

27. The method of claim 26, wherein the contour selection field includes as one selection a set of contour lines where a value for the x-axis times a value for the y-axis equals a constant.

28. The method of claim 27, wherein the contour selection field includes as another selection a set of contour lines where a value for the y-axis divided by a value for the x-axis equals a constant.

29. The method of claim 26, wherein the means for specifying the first financial metric related to the one or more publicly traded companies for the x-axis and for specifying the second financial metric related to the one or more publicly traded companies for the y-axis comprises:
a first drop-down window for the x-axis that allows a user to select one of a plurality of financial metrics for the x-axis; and
a second drop-down window for the y-axis that allows a user to select one of a plurality of financial metrics for the y-axis.

30. The method of claim 26, wherein the means for specifying the first financial metric related to the one or more publicly traded companies for the x-axis and for specifying the second financial metric related to the one or more publicly traded companies for the y-axis comprises a listing of predefined x-y pairs.

31. The method of claim 26, wherein the interface further comprises a center chart axis selection field that, when selected, centers the x and y axes in the chart.

32. The method of claim 31, wherein the interface further comprises:
a zoom selection field for the x-axis; and
a zoom selection field for the y-axis.

33. The method of claim 32, wherein the interface further comprises:
a maximum x-axis value selection field;
a minimum x-axis value selection field;
a maximum y-axis value selection field; and
a minimum y-axis value selection field.

34. The method of claim 33, wherein the interface further comprises a name selection field for specifying the publicly traded companies.

35. The method of claim 34, wherein the name selection field comprises an industry selection field.

36. The method of claim 35, wherein the lines for each of the publicly traded companies is labeled with an identifier for the company and each marker is labeled with a data indicator.
